(19) United States
(12) Patent Application Publication
(10) Pub. No.: US 2025/0245558 A1
(43) Pub. Date: Jul. 31, 2025

(54) Realtime Data Based Automated IT Support

(71) Applicant: Dell Products L.P., Round Rock, TX (US)

(72) Inventors: Ananya Anchan, Karnataka (IN); Apoorva Neyyanira Ravi, Bangalore (IN); Narotham Raghunandan, Bangalore (IN)

(73) Assignee: Dell Products L.P., Round Rock, TX (US)

(21) Appl. No.: 18/427,952

(22) Filed: Jan. 31, 2024

(51) Int. Cl. G06N 20/00; H04L 9/40; H04L 51/02

(52) U.S. Cl. CPC G06N 20/00; H04L 63/08; H04L 51/02

(57) ABSTRACT

Methods, system, and non-transitory processor-readable storage medium for a chatbot support system are provided herein. An example method includes the chatbot support system training a machine learning system, where the machine learning system is trained with remote session data obtained on a first client system. A chatbot application on a second client system receives a support request from a user. The chatbot application obtains a resolution for the support request from the machine learning system, and outputs on the second client system the resolution for the user.

### FIELD

The field relates generally to training a chatbot application, and more particularly to training a chatbot application used in information processing systems for customer support.

### BACKGROUND

Customer support IT systems are essential as they help provide immediate, efficient, and personalized support to increase productivity, improve user experience, and enhance overall efficiency of the organization. Customers frequently access chatbot applications to quickly locate answers/solutions to issues they face when interacting with information processing systems.

### SUMMARY

Illustrative embodiments provide techniques for implementing a chatbot support system in a storage system. For example, illustrative embodiments provide a chatbot support system that trains a machine learning system, where the machine learning system is trained with remote session data obtained on a first client system. A chatbot application on a second client system receives a support request from a user. The chatbot application obtains a resolution for the support request from the machine learning system, and outputs on the second client system the resolution for the user. Other types of processing devices can be used in other embodiments. These and other illustrative embodiments include, without limitation, apparatus, systems, methods and processor-readable storage media.

### BRIEF DESCRIPTION OF THE DRAWINGS

FIG. 1 shows an information processing system including a chatbot support system in an illustrative embodiment.

FIG. 2 shows a chatbot support system in an illustrative embodiment.

FIG. 3 shows a flow diagram of a process for a chatbot support system in an illustrative embodiment.

FIG. 4 shows a flow diagram of input from two remote sessions stored in a graph format in an illustrative embodiment.

FIG. 5 illustrates an example graph data structure of three remote sessions having a common solution in an illustrative embodiment.

FIG. 6 illustrates an example graph data structure of two remote sessions having a common solution in an illustrative embodiment.

FIG. 7 illustrates an example graph data structure of one remote session having a common solution in an illustrative embodiment.

FIG. 8 illustrates a normalized graph data structure for six remote sessions in an illustrative embodiment.

FIGS. 9 and 10 show examples of processing platforms that may be utilized to implement at least a portion of chatbot support system embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

Described below is a technique for use in implementing a chatbot support system, which technique may be used to provide, among other things, to train a machine learning system, where the machine learning system is trained with remote session data obtained on a first client system. A chatbot application on a second client system receives a support request from a user. The chatbot application obtains a resolution for the support request from the machine learning system, and outputs on the second client system the resolution for the user. Other types of processing devices can be used in other embodiments.

Conventional technologies fail to focus on the user journeys as the source of training data for the machine learning system behind the chatbot application. Conventional technologies for chatbot applications that gather training data for machine learning systems do not gather data based on the real-time footprints of the customer/user, (i.e., the customer inquiries, technical issues, troubleshooting steps, and resolutions) and therefore, are not reliable as representative of actual user journeys. Conventional technologies for chatbot applications that do not gather training data based on the footprints of the customer/user require frequent updates to the training data, otherwise that training data quickly becomes irrelevant and inaccurate. Conventional technologies for chatbot applications face challenges in understanding the customer/user queries correctly as customer/user may express their queries in different ways. Conventional technologies for chatbot applications that do not gather training data based on the footprints of the customer/user quickly lose customer/user's trust when the chatbot applications deliver inaccurate and/or ineffective resolutions. Conventional technologies for chatbot applications require routing the customer/user's query to various teams, when first level customer support representatives are unable to provide a resolution, and need to escalate the query to more experienced customer support representatives.

By contrast, in at least some implementations in accordance with the current technique as described herein, a chatbot support system trains a machine learning system, where the machine learning system is trained with remote session data obtained on a first client system. A chatbot application on a second client system receives a support request from a user. The chatbot application obtains a resolution for the support request from the machine learning system, and outputs on the second client system the resolution for the user.

Thus, a goal of the current technique is to provide a method and a system that focuses on the user journeys as the source of training data for the machine learning system that powers the chatbot application. Another goal is to provide a chatbot application that is trained with relevant, timely, and accurate data based on the customer inquiries, technical issues, troubleshooting steps, and resolutions. Yet another goal is to avoid routing the customer/user's query to various teams, when first level customer support representatives are unable to provide a resolution, and need to escalate the query to more experienced customer support representatives.

In at least some implementations in accordance with the current technique described herein, the use of a chatbot support system can provide one or more of the following advantages: focusing on the user journeys as the source of training data for the machine learning system that powers the chatbot application, providing a chatbot application that is trained with relevant, timely, and accurate data based on the customer inquiries, technical issues, troubleshooting steps, and resolutions, and avoiding routing the customer/user's query to various teams, when first level customer support representatives are unable to provide a resolution, and need to escalate the query to more experienced customer support representatives.

In contrast to conventional technologies, in at least some implementations in accordance with the current technique as described herein, a chatbot support system trains a machine learning system, where the machine learning system is trained with remote session data obtained on a first client system. A chatbot application on a second client system receives a support request from a user. The chatbot application obtains a resolution for the support request from the machine learning system, and outputs on the second client system the resolution for the user.

In an example embodiment of the current technique, a session initiator module associated with a listener server associated with the chatbot support system transmits a request to deploy a listener module on the first client system. In response, the listener server receives, from the first client system, authentication of a connection to the listener server. The listener server deploys the listener module on the first client system, and initiates a listener session between the listener module and the listener server, where the listener session is initiated to collect the remote session data.

In an example embodiment of the current technique, a customer support system detects that a remote session has been initiated between the first client system and the customer support system, and in response, the customer support system invokes the session initiator module to perform the transmitting.

In an example embodiment of the current technique, the listener module captures the remote session data comprising user actions performed on the first client system, where the user actions are captured in remote session logs.

In an example embodiment of the current technique, the user actions comprise the resolution.

In an example embodiment of the current technique, the remote session logs comprise at least one of user action performed, timestamp, and session identifier.

In an example embodiment of the current technique, the session terminator module detects termination of a remote session on the first client system, where the remote session is between the first client system and the customer support system, and terminates the listener session between the listener module and the listener server. The session terminator module terminates the connection between the first client system and the listener server, and transmits the remote session data to the listener server.

In an example embodiment of the current technique, the chatbot support system stores the remote session data in a database, where the remote session data is stored in a plurality of node data structures, where each of the plurality of node data structures comprises a respective total session count indicating a number of remote sessions comprising a common resolution for the support request.

In an example embodiment of the current technique, the chatbot support system stores the remote session data in a database, where the remote session data is stored in a plurality of graph data structures, where each of the plurality of graph data structures comprises a respective plurality of node data structures.

In an example embodiment of the current technique, the chatbot support system normalizes the respective plurality of node data structures and deduplicating the respective plurality of node data structures to obtain a plurality of unique graph data structures.

In an example embodiment of the current technique, the chatbot support system ranks the plurality of unique graph data structures according to a highest total session count, where the total session count indicates a number of remote sessions comprising a common resolution for the support request, where more relevant resolutions have a higher total session count than less relevant resolutions.

In an example embodiment of the current technique, the chatbot support system preprocesses a plurality of graph data structures to generate input to the machine learning system, where the preprocessing comprises removing duplicate node data structures from a respective graph data structure, where the plurality of graph data structures each comprise a respective plurality of node data structures.

In an example embodiment of the current technique, the chatbot support system preprocesses a plurality of graph data structures to generate input to the machine learning system, where the preprocessing comprises encoding a subset of a plurality of node data structures into numerical values for analysis, where the plurality of graph data structures each comprise a respective plurality of node data structures.

In an example embodiment of the current technique, the chatbot support system preprocesses the support request received by the chatbot application, where the support request is cleaned and normalized.

In an example embodiment of the current technique, the chatbot support system extracts features of the support request using a natural language processing (NLP) technique comprising TF-IDF.

In an example embodiment of the current technique, the chatbot support system provides as input to the machine learning system a plurality of preprocessed graph data structures, where the machine learning system comprises a Bidirectional Encoder Representations from Transformers (BERT) model.

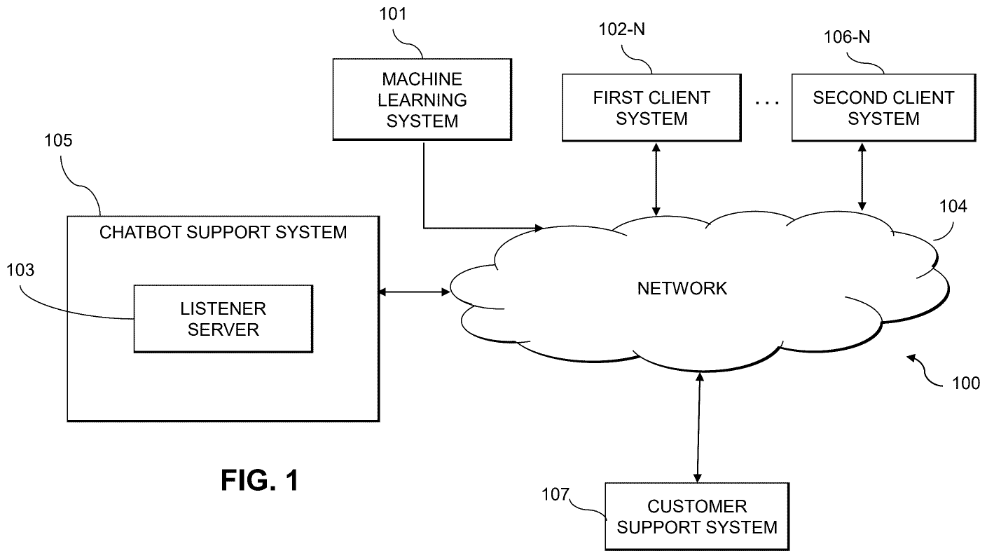

FIG. 1 shows a computer network (also referred to herein as an information processing system) 100 configured in accordance with an illustrative embodiment. The computer network 100 comprises a machine learning system 101, chatbot support system 105, listener server 103, first client system 102-N, second client system 106-N, and customer support system 107. The machine learning system 101, chatbot support system 105, listener server 103, first client system 102-N, second client system 106-N, and customer support system 107 are coupled to a network 104, where the network 104 in this embodiment is assumed to represent a sub-network or other related portion of the larger computer network 100. Accordingly, elements 100 and 104 are both referred to herein as examples of “networks”, but the latter is assumed to be a component of the former in the context of the FIG. 1 embodiment. The chatbot support system 105 may reside on a storage system. Such storage systems can comprise any of a variety of different types of storage including network-attached storage (NAS), storage area networks (SANs), direct-attached storage (DAS) and distributed DAS, as well as combinations of these and other storage types, including software-defined storage.

Each of the first client system 102-N, second client system 106-N, and customer support system 107 may comprise, for example, servers and/or portions of one or more server systems, as well as devices such as mobile telephones, laptop computers, tablet computers, desktop computers or other types of computing devices. Such devices are examples of what are more generally referred to herein as “processing devices.” Some of these processing devices are also generally referred to herein as “computers.”

The first client system 102-N, second client system 106-N, and customer support system 107 in some embodiments comprise respective computers associated with a particular company, organization or other enterprise. In addition, at least portions of the computer network 100 may also be referred to herein as collectively comprising an “enterprise network”, where elements of the enterprise network may execute enterprise applications. Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Also associated with the chatbot support system 105 are one or more input-output devices, which illustratively comprise keyboards, displays or other types of input-output devices in any combination. Such input-output devices can be used, for example, to support one or more user interfaces to the chatbot support system 105, as well as to support communication between the chatbot support system 105 and other related systems and devices not explicitly shown. For example, a dashboard may be provided for a user to view a progression of the execution of the chatbot support system 105. One or more input-output devices may also be associated with any of the first client system 102-N, second client system 106-N, and customer support system 107.

Additionally, the chatbot support system 105 in the FIG. 1 embodiment is assumed to be implemented using at least one processing device. Each such processing device generally comprises at least one processor and an associated memory, and implements one or more functional modules for controlling certain features of the chatbot support system 105.

More particularly, the chatbot support system 105 in this embodiment can comprise a processor coupled to a memory and a network interface.

The processor illustratively comprises a microprocessor, a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the chatbot support system 105 to communicate over the network 104 with the server 103, machine learning system 101, first client system 102-N, second client system 106-N, and customer support system 107, and illustratively comprises one or more conventional transceivers.

A chatbot support system 105 may be implemented at least in part in the form of software that is stored in memory and executed by a processor, and may reside in any processing device. The chatbot support system 105 may be a standalone plugin that may be included within a processing device.

It is to be understood that the particular set of elements shown in FIG. 1 for chatbot support system 105 involving the machine learning system 101, first client system 102-N, second client system 106-N, and customer support system 107 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, one or more of the chatbot support system 105 can be on and/or part of the same processing platform.

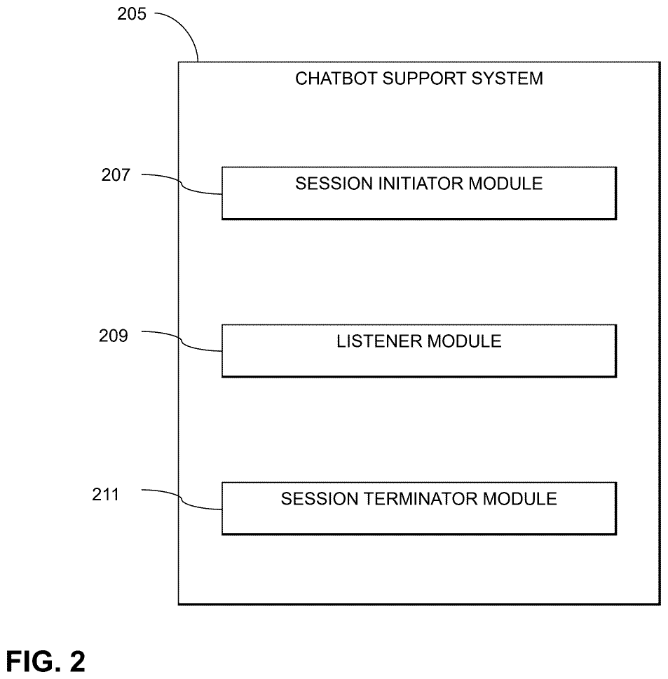

FIG. 2 shows a chatbot support system 205 in an illustrative embodiment. In an example embodiment, the chatbot support system 205 comprises the session initiator module 207, listener module 209, and session terminator module 211. In an example embodiment, when the remote session is triggered, based on customer/user authentication, the listener module 209 is deployed to the first client system 102-N to capture the customer/user actions on the first client system 102-N and generate an activity log. The deployment of the listener module 209 initiates the listener session. In an example embodiment, in response to deploying the listener module 209 to the first client system 102-N, the listener server 103 receives from the first client system 102-N authentication of a connection between the first client system 102-N to the listener server 103. In an example embodiment, the listener server 103 deploys the listener module 209 on the first client system 102-N, and initiates a listener session between the listener module and the listener server, where the listener session is initiated to collect the remote session data. In an example embodiment, a session terminator module 211 detects that the remote session on the first client system 102-N between the first client system 102-N and the customer support system 107 has been terminated. In response, the session terminator module 211 terminates the listener session between the listener module 209 and the first client system 102-N. In addition, the session terminator module 211 terminates the connection between the first client system 102-N and the listener server 103. In an example embodiment, the session terminator module 211 then transmits the remote session data, which has been saved into the remote session activity logs to the listener server 103.

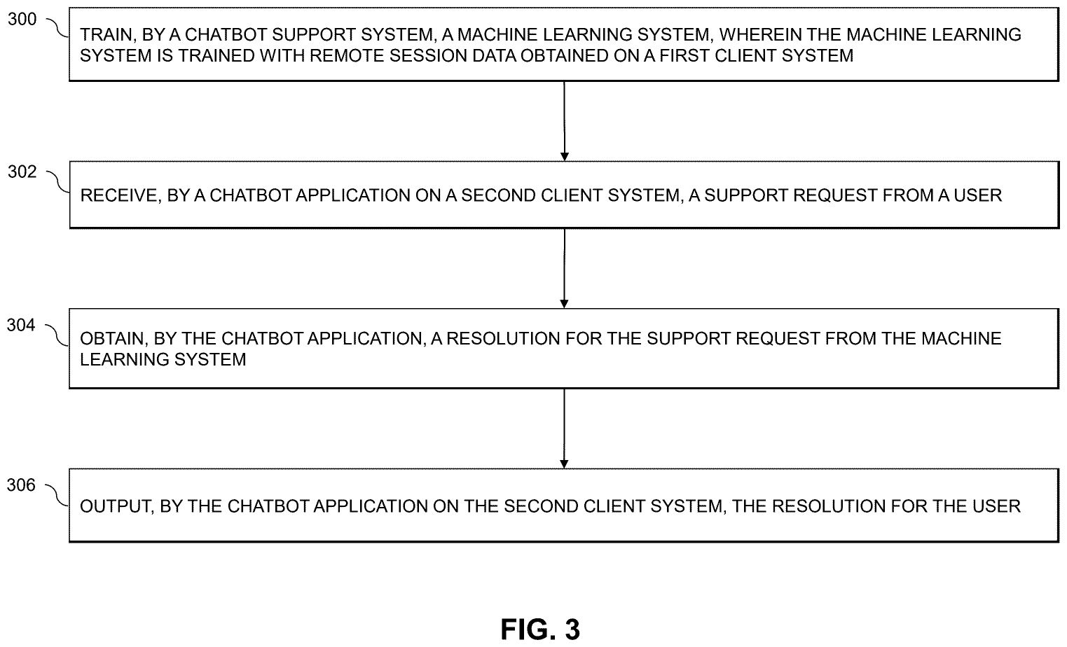

FIG. 3 is a flow diagram of a process for execution of the chatbot support system 105 in an illustrative embodiment. It is to be understood that this particular process is only an example, and additional or alternative processes can be carried out in other embodiments.

At 300, the chatbot support system 105 trains a machine learning system 101, where the machine learning system 101 is trained with remote session data obtained on a first client system 102-N. The remote session data is captured between a customer and the customer support system 107 during an interactive information technology (IT) remote session, where a customer support representative, using the customer support system 107, assists a customer with the customer's inquiries, technical issues, trouble shooting steps, resolutions, etc. Thus, the training data for the machine learning system 101 gathered during the remote sessions, is based on the footprints of the customer and captures the customer's journey. The usability issues faced by the customer/user during usage of an application are captured during the remote session. In an example embodiment, these usability issues are categorized, and the relevant data is shared with the development team for resolution, as well as being added to the training data set to train the machine learning system 101. In an example embodiment, the chatbot support system 105 detects that a remote session has been initiated between the first client system 102-N and the customer support system 107. In response, the chatbot support system 105 invokes the session initiator module 207 to transmit the listener module 209 to the first client system 102-N.

In an example embodiment, a session initiator module 207 associated with a listener server 103 associated with the chatbot support system 105 transmits a request to deploy a listener module 209 on the first client system 102-N. FIG. 2 illustrates a chatbot support system 105 comprising a session initiator module 207, listener module 209, and session terminator module 211. In an example embodiment, when the remote session is triggered, based on customer/user authentication, the listener module 209 is deployed to the first client system 102-N to capture the customer/user actions on the first client system 102-N and generate an activity log. The deployment of the listener module 209 initiates the listener session. In an example embodiment, in response to deploying the listener module 209 to the first client system 102-N, the listener server 103 receives from the first client system 102-N authentication of a connection between the first client system 102-N and the listener server 103. In an example embodiment, the listener server 103 deploys the listener module 209 on the first client system 102-N, and initiates a listener session between the listener module and the listener server, where the listener session is initiated to collect the remote session data. Thus, once deployed, the listener module 209 captures the remote session data comprising user actions performed on the first client system 102-N, where the customer/user's actions are captured and recorded the in remote session activity logs. In an example embodiment, the remote session activity logs comprise at least one of user action performed, timestamp, and session identifier. In an example embodiment, the remote session activity logs follow design guidelines and security standards.

In an example embodiment, a session terminator module 211 detects that the remote session on the first client system 102-N between the first client system 102-N and the customer support system 107 has been terminated. In response, the session terminator module 211 terminates the listener session between the listener module 209 and the first client system 102-N. In addition, the session terminator module 211 terminates the connection between the first client system 102-N and the listener server 103. In an example embodiment, the session terminator module 211 then transmits the remote session data, which has been saved into the remote session activity logs to the listener server 103.

In an example embodiment, the listener module 209 writes the data of the remote session activity into the remote session activity logs. In the remote session activity logs, real time error messages from the errors/warnings are captured, making the remote session activity logs, which are used to train the machine learning system 101, more reliable. Illustrated below are examples remote session activity logs of a first session (“Session 1”) and a second session (“Session 2”).

### Session 1:

| | Activity | | |
|---|---|---|---|
| Session id | Type | Action | Timestamp |
| qEsty7520UioQ89 | User is | Navigated to system | 2023 Jul. 25 14:58:28 |
| | unable to | tray | |
| | access | | |
| | VPN | | |
| qEsty7520UioQ89 | | Select VPN client | 2023 Jul. 25 14:58:33 |
| qEsty7520UioQ89 | | User enters username | 2023 Jul. 25 14:58:58 |
| qEsty7520UioQ89 | | User enters password | 2023 Jul. 25 14:59:05 |
| qEsty7520UioQ89 | | Click Connect | 2023 Jul. 25 14:59:16 |
| qEsty7520UioQ89 | | Error screen pops | 2023 Jul. 25 14:59:20 |
| | | up-Authentication | |
| | | Failed/Error | |
| qEsty7520UioQ89 | | User clicks OK | 2023 Jul. 25 14:59:30 |
| qEsty7520UioQ89 | | Navigated to system | 2023 Jul. 25 14:59:40 |
| | | tray | |
| | | Select VPN client | 2023 Jul. 25 14:59:42 |
| qEsty7520UioQ89 | | Navigated to settings | 2023 Jul. 25 14:59:45 |
| qEsty7520UioQ89 | | Navigated to | 2023 Jul. 25 14:59:55 |
| | | Authentication | |
| qEsty7520UioQ89 | | Click on Clear | 2023 Jul. 25 14:60:15 |
| | | Credentials | |
| qEsty7520UioQ89 | | Navigated to VPN | 2023 Jul. 25 14:60:20 |
| | | Client | |
| qEsty7520UioQ89 | | User enters username | 2023 Jul. 25 14:60:25 |
| qEsty7520UioQ89 | | User enters password | 2023 Jul. 25 14:60:40 |
| qEsty7520UioQ89 | | Click Connect | 2023 Jul. 25 15:00:05 |
| qEsty7520UioQ89 | | Window appears: | 2023 Jul. 25 15:00:15 |
| | | Connection | |
| | | successful | |

### Session 2:

| | Activity | | |
|---|---|---|---|
| Session id | Type | Action | Timestamp |
| oEpty7520UioQ00 | User is | User navigates to | 2023 Jul. 25 16:58:28 |
| | unable to | system tray | |
| | access | | |
| | VPN | | |
| oEpty7520UioQ00 | | Select VPN client | 2023 Jul. 25 16:58:58 |
| | | User enters username | 2023 Jul. 25 16:58:60 |
| oEpty7520UioQ00 | | User enters password | 2023 Jul. 25 16:59:05 |
| oEpty7520UioQ00 | | Click Connect | 2023 Jul. 25 16:59:16 |
| oEpty7520UioQ00 | | Error screen pops | 2023 Jul. 25 16:59:20 |
| | | up-Connection | |
| | | Timed Out | |
| oEpty7520UioQ00 | | User clicks OK | 2023 Jul. 25 16:59:30 |
| oEpty7520UioQ00 | | Change the VPN | 2023 Jul. 25 16:59:40 |
| | | gateway to-XXX | |
| oEpty7520UioQ00 | | Click Connect | 2023 Jul. 25 16:59:45 |
| oEpty7520UioQ00 | | Error screen pops | 2023 Jul. 25 16:59:55 |
| | | up-Connection | |
| | | Timed Out | |
| oEpty7520UioQ00 | | User clicks OK | 2023 Jul. 25 16:60:15 |
| oEpty7520UioQ00 | | User navigates to | 2023 Jul. 25 16:60:20 |
| | | VPN Client | |
| oEpty7520UioQ00 | | User navigates to | 2023 Jul. 25 16:60:25 |
| | | updates | |
| oEpty7520UioQ00 | | Click on update | 2023 Jul. 25 16:60:40 |
| oEpty7520UioQ00 | | User clicks back | 2023 Jul. 25 17:00:05 |
| oEpty7520UioQ00 | | Click Connect | 2023 Jul. 25 17:00:15 |
| oEpty7520UioQ00 | | Window appears: | 2023 Jul. 25 17:00:18 |
| | | Connection | |
| | | successful | |

In an example embodiment, the chatbot support system 105 stores the remote session activity data (also referred to as remote session data) in a database. The remote session data is stored in a plurality of node data structures, where each of the plurality of node data structures comprises a respective total session count indicating a number of remote sessions comprising a common resolution for the support request.

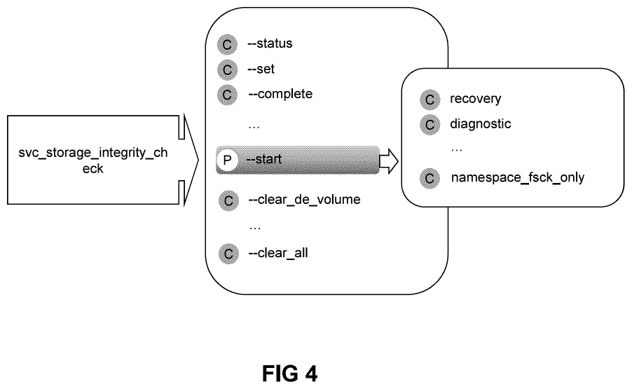

In an example embodiment, the chatbot support system 105 stores the remote session data in a database. The remote session data is stored in a plurality of graph data structures, where each of the plurality of graph data structures comprises a respective plurality of node data structures. The input from Session 1 and Session 2, illustrated above, is stored in a graph format. The graph is then normalized to eliminate the redundancies. FIG. 4 illustrates the unique graph data structures that are retained from Session 1 and Session 2 data.

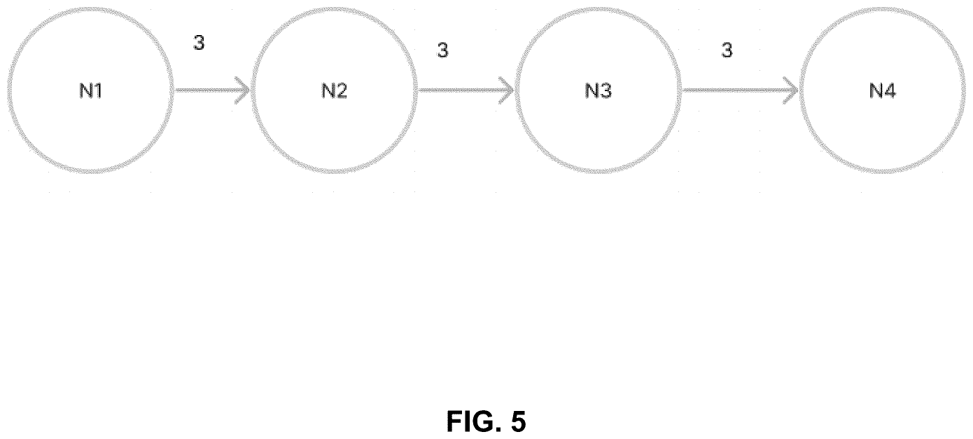

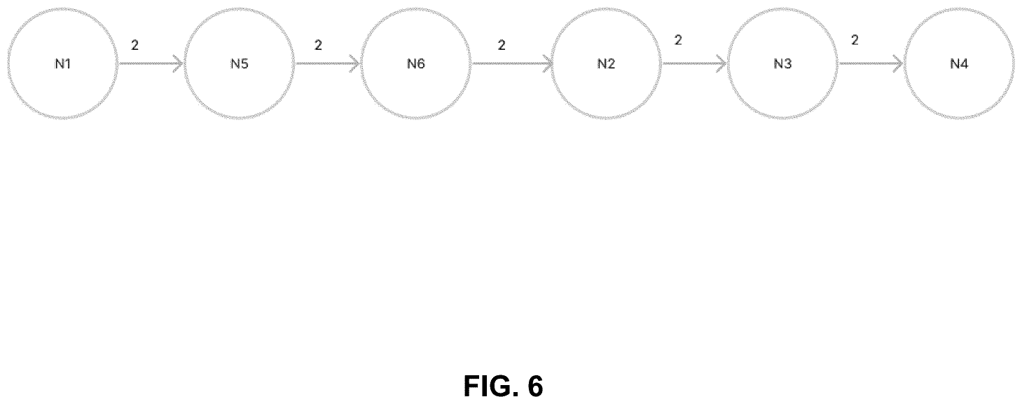

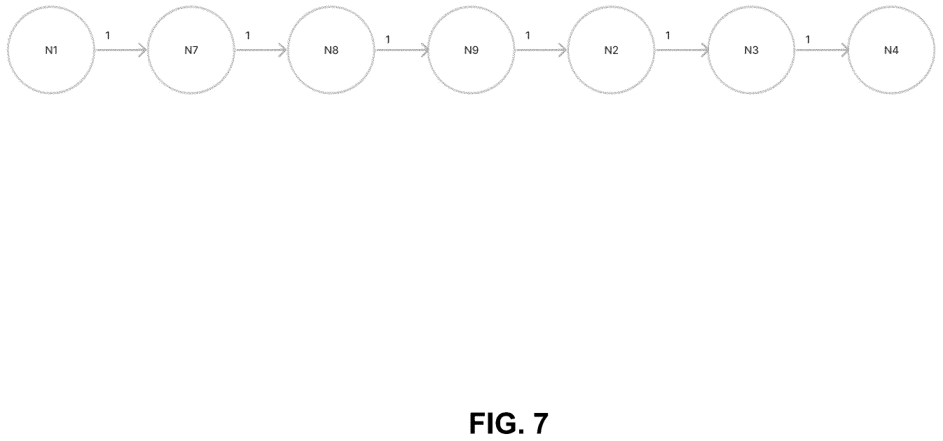

In an example embodiment, at each node, a total session count (contributing to that node) is stored. In an example embodiment, there are six different remote sessions. Three sessions (i.e., Session 1, Session 2, and Session 3) have a common solution, therefore “Solution 1” has a total session count of three as illustrated in FIG. 5. Two sessions (i.e., Session 4 and Session 5) have a common solution, therefore “Solution 2” has a total session count of two, as illustrated in FIG. 6. One session (i.e., Session 6) has a unique solution, therefore “Solution 3” has a total session count of one, as illustrated in FIG. 7. In an example embodiment, the chatbot support system 105 identifies unique paths for each Request ID, where every call to the customer support system 107 is assigned a unique Request ID, to track the lifecycle of that particular call.

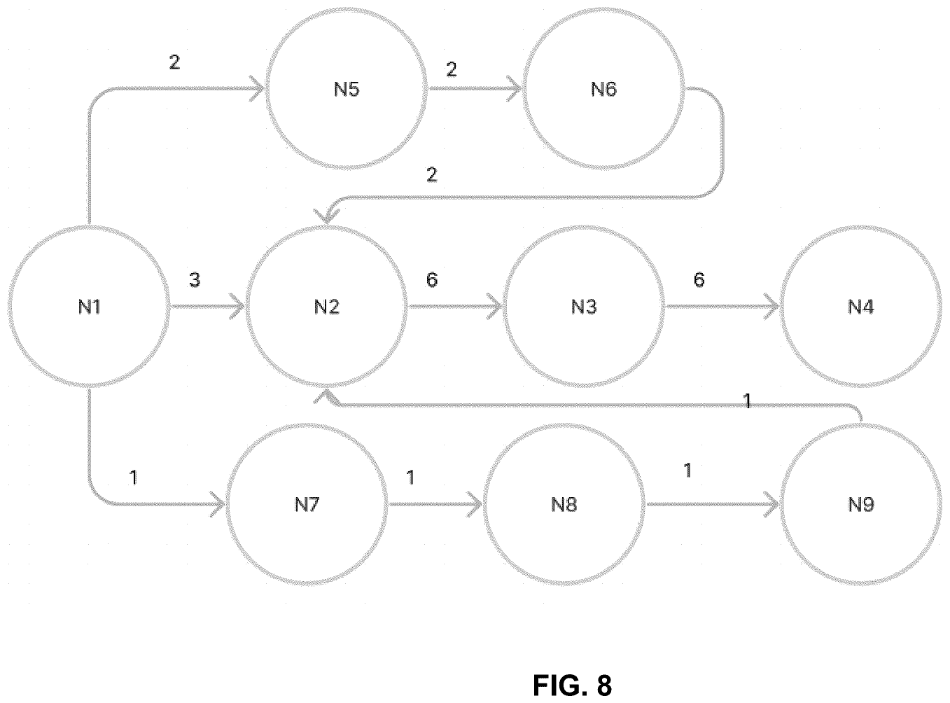

In an example embodiment, the chatbot support system 105 normalizes each plurality of node data structures the comprise a single graph node structure, and deduplicates each of the plurality of node data structures such that the result is a plurality of unique graph data structures as illustrated in FIG. 8. FIG. 8 illustrates the normalized graph for Sessions 1, 2, 3, 4, 5, and 6.

In an example embodiment, the chatbot support system 105 ranks the plurality of unique graph data structures according to a highest total session count, where the total session count indicates a number of remote sessions comprising a common resolution for the support request. In an example embodiment, the more relevant resolutions have a higher total session count than the less relevant resolutions. In an example embodiment, the chatbot support system 105 prioritizes the solution for the support request based on the highest total count of sessions, for example, for Sessions 1, 2, 3, 4, 5, and 6.

In an example embodiment, the chatbot support system 105 preprocesses a plurality of graph data structures to generate input to the machine learning system. The preprocessing comprises removing duplicate node data structures from a respective graph data structure, where the plurality of graph data structures each comprise a respective plurality of node data structures. In an example embodiment, the graph data structures undergo data cleaning where node/edge normalization occurs, and where the chatbot support system 105 handles missing values in the graph data structures. The data cleaning, normalizing, and handling of missing values helps in maintaining the structural integrity of the graph data structures. This is crucial for accurate representation and interpretation of the relationships within the graph data structures. In an example embodiment, the data cleaning removes the duplicate node (or edges) data structures in the graph data structures, and also removes any irrelevant information from the graph data structures. Redundant information may arise from multiple representations of the same entity or relationship. The normalizing of the node data structures (and edge attributes) assists in bringing them to a similar scale. For example, if the node data structures have categorical attributes, such as user roles or device information, those node data structures are encoded into numerical values for analysis. As noted above, the chatbot support system 105 handles missing values. Flagging missing data allows the chatbot support system 105 to preserve information about the absence of certain values, and can be crucial for understanding the completeness of the dataset.

In an example embodiment, the chatbot support system 105 preprocesses a plurality of graph data structures to generate input to the machine learning system. The preprocessing encodes a subset of a plurality of node data structures into numerical values for analysis, where the plurality of graph data structures each comprise a respective plurality of node data structures. In an example embodiment, the graph data structures and textual data is converted into numerical or feature representations that are used by the machine learning algorithm. Once the graph features and text embedding are obtained, the chatbot support system 105 aligns and fuses these representations. Concatenation is used to concatenate the graph features and text embedding into a single feature vector, and the concatenated vector is the input into the machine learning system 101. In an example embodiment, features are extracted and insights are gained from the graph data structures. In an example embodiment, graph embedding techniques, such as Word2Vec, is used to represent node data structures and edges as vectors. In an example embodiment, Bidirectional Encoder Representations from Transformers (BERT) or Generative pre-trained Transformer (GPT) is used to convert text into numerical representation.

The remote session activity logs that are captured by the listener module 209 are processed into a plurality of graph data structures, specifically unique graph data structures, and preprocessed to generate the training data for the machine learning system 101. The training data is fed to the chatbot application to provide a quick reference to real-time scenarios to the customer service representative as, for example, the customer service representative assists a user/customer. This provides more accurate and reliable information for the customer support representative to provide to the customer, acts as training support for new customer support representatives (who can get started assisting customers/users with minimal training sessions), and eliminate numerous routing/loops that a customer may be sent on if an initial customer service representative cannot provide a resolution to the user's/customer's issue. This reduces downtime, improves the turnaround time, minimizes productivity losses, and eliminates maintenance activity.

At 302, a chatbot application on a second client system receives a support request from a customer/user. For example, the customer inputs a query/request as input into the chatbot application, or a customer support representative inputs the query/request as the input to the chatbot. In the first example, the customer may invoke the chatbot application and enter a request. In the second example, a customer support representative may be assisting a customer through a variety of methods (i.e., phone support, remote session, etc.) and the customer support representative may enter the customer's query/request as the input into the chatbot application.

In an example embodiment, the chatbot support system 105 preprocesses the support request received by the chatbot application, where the support request is cleaned and normalized. For example, the text of the customer's query/request is cleaned and normalized. In an example embodiment, the chatbot support system 105 extracts features of the support request using a natural language processing (NLP) technique comprising TF-IDF. For example, the chatbot support system 105 may use a variety of natural language processing techniques. The extracted features are passed to the machine learning system 101.

In an example embodiment, the chatbot support system 105 provides as input to the machine learning system a plurality of preprocessed graph data structures, where the machine learning system comprises a Bidirectional Encoder Representations from Transformers (BERT) model. In an example embodiment, the concatenated vector mentioned above is used as input to the BERT model. BERT uses a bidirectional training approach that enables this model to capture complex relationships and dependencies in language. Chatbot application interactions require an understanding of the conversation to provide relevant responses. Chatbot applications need to understand and respond to diverse user queries. BERT's bidirectional nature allows it to capture contextual information effectively, as it considers the entire input sequence. This enables the chatbot to generate responses that are more contextually accurate and coherent. It excels in understanding complex language nuances, making it suitable for chatbot applications where precise interpretation is crucial.

In an example embodiment, the chatbot support system 105 trains the machine learning system. The preprocessed data (i.e., the unique graph data structures), are split into a training set and a testing set. For example, 20% of the unique node data structures are used to train the machine learning system and 80% of the unique node data structures are used to test the machine learning system, and evaluate the machine learning system's performance. In an example embodiment, the training set of data from the evaluated model is passed as the input into the chatbot application. In an example embodiment, training data is created periodically (i.e., auto generated from remote session data) to continually update the machine learning system 101. In an example embodiment, the training set of data is used as a quick reference within the chatbot application for newly onboarded customer service representatives.

At 304, the chatbot application obtains a resolution for the support request from the machine learning system. In an example embodiment, the extracted features that are extracted from the query/request are inputted into the machine learning system 101. The machine learning system 101 processes the extracted features, and generates predictions or outputs based on the trained parameters and learned patterns. The output from the machine learning system 101 is used to generate meaningful responses using Natural Language Generation. Thus, the user receives immediate assistance for their technical issues.

At 306, the chatbot application outputs on the second client system, the resolution for the user. In an example embodiment, the interactive chatbot application displays the response for the user's/customer's request/query to the user interface of the chatbot application. In an example embodiment, user feedback is captured by the chatbot support system 105 to further refine the machine learning system 101, update the training data, and enhance the customer support's/chatbot application's ability to provide more accurate and meaningful information.

Accordingly, the particular processing operations and other functionality described in conjunction with the flow diagram of FIG. 3 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to provide actual user journeys to train a chatbot application. These and other embodiments can effectively ensure that customers using the chatbot application receive accurate resolutions to their issues in real-time relative to conventional approaches. Embodiments disclosed herein focuses on the user journeys as the source of training data for the machine learning system that powers the chatbot application. Embodiments disclosed herein provide a chatbot application that is trained with relevant, timely, and accurate data based on the customer inquiries, technical issues, troubleshooting steps and resolutions. Embodiments disclosed herein avoid routing the customer/user's query to various teams, when first level customer support representatives are unable to provide a resolution, and need to escalate the query to more experienced customer support representatives.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the information processing system 100. For example, containers can be used to implement respective processing devices providing compute and/or storage services of a cloud-based system. Again, containers may be used in combination with other virtualization infrastructure such as virtual machines implemented using a hypervisor.

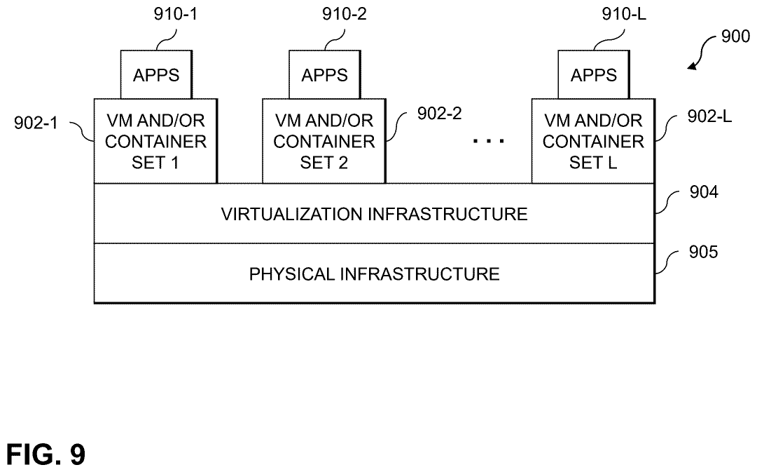

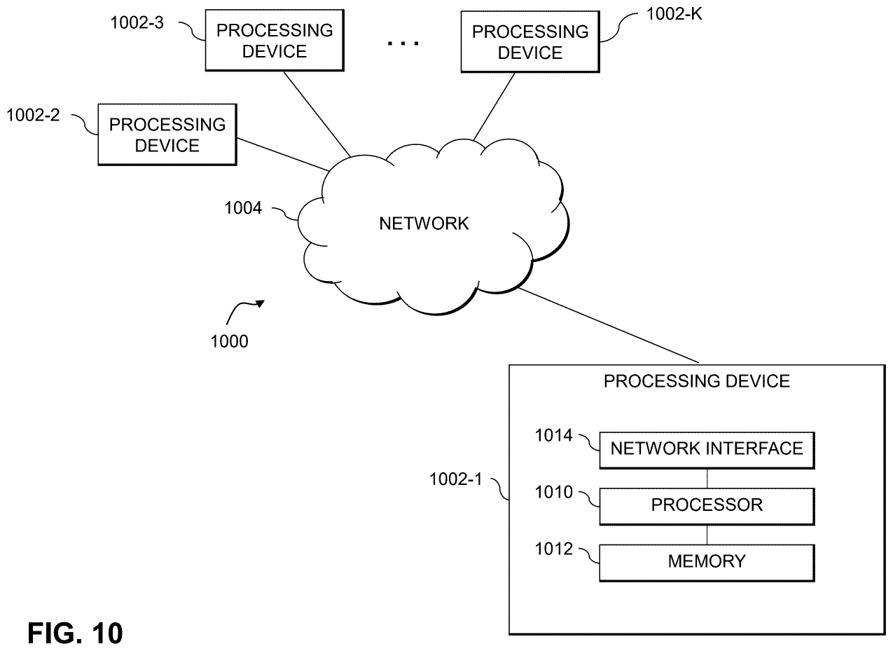

Illustrative embodiments of processing platforms will now be described in greater detail with reference to FIGS. 9 and 10. Although described in the context of the information processing system 100, these platforms may also be used to implement at least portions of other information processing systems in other embodiments.

FIG. 9 shows an example processing platform comprising cloud infrastructure 900. The cloud infrastructure 900 comprises a combination of physical and virtual processing resources that are utilized to implement at least a portion of the information processing system 100. The cloud infrastructure 900 comprises multiple virtual machines (VMs) and/or container sets 902-1, 902-2, . . . 902-L implemented using virtualization infrastructure 904. The virtualization infrastructure 904 runs on physical infrastructure 905, and illustratively comprises one or more hypervisors and/or operating system level virtualization infrastructure. The operating system level virtualization infrastructure illustratively comprises kernel control groups of a Linux operating system or other type of operating system.

The cloud infrastructure 900 further comprises sets of applications 910-1, 910-2, . . . 910-L running on respective ones of the VMs/container sets 902-1, 902-2, . . . 902-L under the control of the virtualization infrastructure 904. The VMs/container sets 902 comprise respective VMs, respective sets of one or more containers, or respective sets of one or more containers running in VMs. In some implementations of the FIG. 9 embodiment, the VMs/container sets 902 comprise respective VMs implemented using virtualization infrastructure 904 that comprises at least one hypervisor.

A hypervisor platform may be used to implement a hypervisor within the virtualization infrastructure 904, where the hypervisor platform has an associated virtual infrastructure management system. The underlying physical machines comprise one or more distributed processing platforms that include one or more storage systems.

In other implementations of the FIG. 9 embodiment, the VMs/container sets 902 comprise respective containers implemented using virtualization infrastructure 904 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of the information processing system 100 may each run on a computer, server, storage device or other processing platform element. A given such element is viewed as an example of what is more generally referred to herein as a “processing device.” The cloud infrastructure 900 shown in FIG. 9 may represent at least a portion of one processing platform. Another example of such a processing platform is processing platform 1000 shown in FIG. 10.

The processing platform 1000 in this embodiment comprises a portion of the information processing system 100 and includes a plurality of processing devices, denoted 1002-1, 1002-2, 1002-3, . . . 1002-K, which communicate with one another over a network 1004.

The network 1004 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 1002-1 in the processing platform 1000 comprises a processor 1010 coupled to a memory 1012.

The processor 1010 comprises a microprocessor, a microcontroller, an application-specific integrated circuit (ASIC), a field-programmable gate array (FPGA) or other type of processing circuitry, as well as portions or combinations of such circuitry elements.

The memory 1012 comprises random access memory (RAM), read-only memory (ROM) or other types of memory, in any combination. The memory 1012 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1002-1 is network interface circuitry 1014, which is used to interface the processing device with the network 804 and other system components, and may comprise conventional transceivers.

The other processing devices 1002 of the processing platform 1000 are assumed to be configured in a manner similar to that shown for processing device 1002-1 in the figure.

Again, the particular processing platform 1000 shown in the figure is presented by way of example only, and the information processing system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of a distributed processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method comprising:
training, by a chatbot support system, a machine learning system, wherein the machine learning system is trained with remote session data obtained on a first client system;
receiving, by a chatbot application on a second client system, a support request from a user;
obtaining, by the chatbot application, a resolution for the support request from the machine learning system; and
outputting, by the chatbot application on the second client system, the resolution for the user, wherein the method is implemented by at least one processing device comprising a processor coupled to a memory.

2. The method of claim 1 wherein training, by the chatbot support system, the machine learning system comprises:
transmitting, by a session initiator module associated with a listener server associated with the chatbot support system, a request to deploy a listener module on the first client system;
in response, receiving by the listener server, from the first client system, authentication of a connection to the listener server;
deploying, by the listener server, the listener module on the first client system; and
initiating a listener session between the listener module and the listener server, the listener session initiated to collect the remote session data.

3. The method of claim 2 further comprising:
detecting that a remote session has been initiated between the first client system and a customer support system; and
in response, invoking the session initiator module to perform the transmitting.

4. The method of claim 2 further comprising:
capturing, by the listener module, the remote session data comprising user actions performed on the first client system, wherein the user actions are captured in remote session logs.

5. The method of claim 4 wherein the user actions comprise the resolution.

6. The method of claim 4 wherein the remote session logs comprise at least one of user action performed, timestamp, and session identifier.

7. The method of claim 2 further comprising:
detecting, by a session terminator module, termination of a remote session on the first client system, wherein the remote session is between the first client system and the customer support system;
terminating, by the session terminator module, the listener session between the listener module and the listener server;
terminating, by the session terminator module, the connection between the first client system and the listener server; and
transmitting, by the session terminator module, the remote session data to the listener server.

8. The method of claim 1 wherein training, by the chatbot support system, the machine learning system comprises:
storing the remote session data in a database, wherein the remote session data is stored in a plurality of node data structures, wherein each of the plurality of node data structures comprises a respective total session count indicating a number of remote sessions comprising a common resolution for the support request.

9. The method of claim 1 wherein training, by the chatbot support system, the machine learning system comprises:
storing the remote session data in a database, wherein the remote session data is stored in a plurality of graph data structures, wherein each of the plurality of graph data structures comprises a respective plurality of node data structures.

10. The method of claim 9 further comprising:
normalizing the respective plurality of node data structures and deduplicating the respective plurality of node data structures to obtain a plurality of unique graph data structures.

11. The method of claim 10 further comprising:
ranking the plurality of unique graph data structures according to a highest total session count, wherein the total session count indicates a number of remote sessions comprising a common resolution for the support request, wherein more relevant resolutions have a higher total session count than less relevant resolutions.

12. The method of claim 1 wherein training, by the chatbot support system, the machine learning system comprises:
preprocessing a plurality of graph data structures to generate input to the machine learning system, wherein the preprocessing comprises removing duplicate node data structures from a respective graph data structure, wherein the plurality of graph data structures each comprise a respective plurality of node data structures.

13. The method of claim 1 wherein training, by the chatbot support system, the machine learning system comprises:
preprocessing a plurality of graph data structures to generate input to the machine learning system, wherein the preprocessing comprises encoding a subset of a plurality of node data structures into numerical values for analysis, wherein the plurality of graph data structures each comprise a respective plurality of node data structures.

14. The method of claim 1 wherein receiving, by the chatbot application on the second client system, the support request from the user comprises:
preprocessing the support request received by the chatbot application, wherein the support request is cleaned and normalized.

15. The method of claim 1 wherein receiving, by the chatbot application on the second client system, the support request from the user comprises:
extracting features of the support request using a natural language processing (NLP) technique comprising TF-IDF.

16. The method of claim 1 wherein receiving, by the chatbot application on the second client system, the support request from the user comprises:
providing as input to the machine learning system a plurality of preprocessed graph data structures, wherein the machine learning system comprises a Bidirectional Encoder Representations from Transformers (BERT) model.

17. A system comprising:
at least one processing device comprising a processor coupled to a memory;
the at least one processing device being configured:
to train, by a chatbot support system, a machine learning system, wherein the machine learning system is trained with remote session data obtained on a first client system;
to receive, by a chatbot application on a second client system, a support request from a user;
to obtain, by the chatbot application, a resolution for the support request from the machine learning system; and
to output, by the chatbot application on the second client system, the resolution for the user.

18. The system of claim 17 wherein the at least one processing device being configured to train, by the chatbot support system, the machine learning system is further configured to:
transmit, by a session initiator module associated with a listener server associated with the chatbot support system, a request to deploy a listener module on the first client system;
in response, receive by the listener server, from the first client system, authentication of a connection to the listener server;
deploy, by the listener server, the listener module on the first client system; and
initiate a listener session between the listener module and the listener server, the listener session initiated to collect the remote session data.

19. A computer program product comprising a non-transitory processor-readable storage medium having stored therein program code of one or more software programs, wherein the program code when executed by at least one processing device causes said at least one processing device:
to train, by a chatbot support system, a machine learning system, wherein the machine learning system is trained with remote session data obtained on a first client system;
to receive, by a chatbot application on a second client system, a support request from a user;
to obtain, by the chatbot application, a resolution for the support request from the machine learning system; and
to output, by the chatbot application on the second client system, the resolution for the user.

20. The computer program product of claim 19 wherein when the program code causes the at least one processing device to train, by the chatbot support system, the machine learning system, the program code causes the at least one processing device to:
transmit, by a session initiator module associated with a listener server associated with the chatbot support system, a request to deploy a listener module on the first client system;
in response, receive by the listener server, from the first client system, authentication of a connection to the listener server;
deploy, by the listener server, the listener module on the first client system; and
initiate a listener session between the listener module and the listener server, the listener session initiated to collect the remote session data.
